(19) United States
(12) Patent Application Publication
(10) Pub. No.: US 2014/0166042 A1
(43) Pub. Date: Jun. 19, 2014

(54) DENTAL FLOSS DEVICE

(71) Applicant: Mary Aragon, Carlsbad, CA (US)

(72) Inventor: Mary Aragon, Carlsbad, CA (US)

(21) Appl. No.: 14/016,115

(22) Filed: Sep. 1, 2013

Related U.S. Application Data
(60) Provisional application No. 61/699,198, filed on Sep. 10, 2012.

(51) Int. Cl. A61C 15/04

(52) U.S. Cl. CPC A61C 15/046
USPC 132/325

(57) ABSTRACT

A dental floss device includes an elongated clam shell body having top and bottom halves joined by a hinge at a bottom and having a closed position during operation and an open position to access a spool with floss therein; a pair of spaced apart prongs extending from one end of said elongated clam shell body, each prong receiving floss threaded therethrough; a ratchet coupled to the spool to prevent turning of the spool when engaged; and a button on one surface of the clam shell body that releases the ratchet and allows floss to be dispensed and engages the ratchet when the button is released to hold the floss.

The present application is a continuation application which claims priority to Provisional Ser. No. 61/699,198 filed Sep. 10, 2012.

The use of hand-held dental floss devices to dispense dental floss is known in the art. Previous designs include means to hold a spool of floss, dispense and hold between a pair of prongs for use. Known prior art hand-held dental floss devices include U. S. Pat. No. 4,844,104; U.S. Pat. No. 5,246,022; U.S. Pat. No. 5,215,193; U.S. Pat. No. 5,016,661; U.S. Pat. No. Des. 306,500; and U.S. Pat. No. 3,894,550.

U.S. Pat. No. 5,996,928 discloses a dental floss device including housing with dental floss stored therein. Also included is at least one dental floss dispensing assembly for dispensing a predetermined length of the dental floss from the housing. The dental floss dispensing assembly includes a slider mounted within the housing for dispensing the floss upon being manually slid via a lever.

U.S. Pat App. No. 20110284023 discloses an orthodontic flosser with an elongated handle and a head coupled to the handle at a vertical angle. A first and second projection extend from the head for suspending floss, the first projection is sized for insertion of floss between a wire affixed to a tooth and the tooth. A source spool of fresh floss is configured to feed fresh floss incrementally into suspension between the first and second projections while a take-up bobbin is configured for taking up used floss and applying tension to the suspended floss. A button may be used for releasing the source spool to rotate, and for holding the source spool against rotation. The source spool and take-up bobbin may be disposed in separated chambers to reduce cross contamination.

### SUMMARY

In one aspect, a dental floss device includes an elongated clam shell body having top and bottom halves joined by a hinge at a bottom and having a closed position during operation and an open position to access a spool with floss therein; a pair of spaced apart prongs extending from one end of said elongated clam shell body, each prong receiving floss threaded therethrough; a ratchet coupled to the spool to prevent turning of the spool when engaged; and a button on one surface of the clam shell body that releases the ratchet and allows floss to be dispensed and engages the ratchet when the button is released to hold the floss.

In another aspect, a dental floss device provides a means to hold a supply of dental floss within a flosser. The flosser can be personally decorated to avoid mismatching and cross-contamination amongst users. The flosser allows for quick and easy dispensing of new lengths of dental floss such that the same area of floss is not used repeatedly thus transferring contaminants around the user's mouth. The flosser includes a pair of prongs to hold the floss for use. The prongs uniquely support flossing by a user who is wearing orthodontic braces.

Implementations of the above aspects can include one or more of the following. A custom floss spool can be used with a spool holder to form a lock-and-release spool assembly. The spool assembly locks in place so that tension can be applied to the floss by pulling and wrapping the floss around a cleat. The spool assembly can be unlocked or released so it can turn when pushing on the button. When the button is released the floss holder assembly then locks again. The floss spool and/or spool assembly are easily replaceable by the user. The floss travels in straight lines where possible and guided by channels, tabs, among others, up and around the prongs before being cleated off. The cleat provides a textured surface so the floss maintains tension yet is easy to unwind for advancing the floss to a fresh section. The case halves open with a double living hinge (two areas of bend). The hinge is recessed when closed so the unit can stand on a flat surface such as a counter top. The case halves snap together securely yet are easily opened without tools so the floss spool or spool assembly can be replaced or the floss re-threaded if it breaks. The floss can be threaded through holes in the prongs. The grooves can include v-shaped protrusions to guide the floss's path during use. In implementation, the thinner floss prong shape is optimized for flossing with braces (through a thin wall section) while remaining strong and durable during the usage. In this embodiment, the dimensions should be approximately 0.040 inch thick and 0.095 inch wide near the end which is slid under the wire of the braces.

Advantages of the flosser may include one or more of the following. The flosser is a novel and easy-to-use, all-in-one dental flosser that can be used by users with and without braces. The flosser is shaped like a monster and can be customized with complementary stickers so users can create and customize their own “Floss Monster”, making it cool and fun and motivating users to floss, especially for those wearing braces. The flosser can include ornamental designs that are appealing to children and that can be customized so that each flosser can be uniquely and individually identified. The dispensing mechanisms reliably maintains tension on the floss while being used and can easily dispense lengths of floss during use to avoid repeatedly using the same length of floss and thereby transferring contaminants from one area to the next. The flosser and floss holder can be used even when the user is wearing dental braces.

Other advantages will become apparent from a consideration of the ensuing description and drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIGS. 1A-1B shows front perspective views of one exemplary dental flossing device.

FIG. 2 is a front-view of the dental flossing device shown in FIG. 1.

FIG. 3 is an inside view of the dental flossing device shown in FIG. 1.

FIGS. 4A-4B are exemplary views of another embodiment of the dental flossing device shown in FIG. 1.

FIG. 5 show side views of the dental flossing device shown in FIG. 1.

FIG. 6 shows top and bottom views of the dental flossing device of FIG. 1.

FIGS. 7A-7B show outside and inside views of a second embodiment of the dental flossing device.

FIG. 8 is a cross-sectional view of the dental device of FIG. 7A.

FIG. 9A shows a cross-sectional view of the flossing device, while FIGS. 9B-9C illustrate the operation of a button/spring axle.

FIGS. 9D-9E show exemplary views of a bobbin and a bobbin with a spool of floss, respectively.

FIG. 9F-9H show exemplary views of the top portion of the flosser of FIGS. 7A-7B with two prongs and a latch thereon.

FIG. 9I shows an exemplary cleat.

FIG. 10 shows an exemplary removable prong and an exemplary base holder to allow the user to use in tight fitting situations.

These and other features and advantages of the preferred embodiment will become apparent from the following detailed description, the accompanying drawings, and the appended claims.

### DETAILED DESCRIPTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

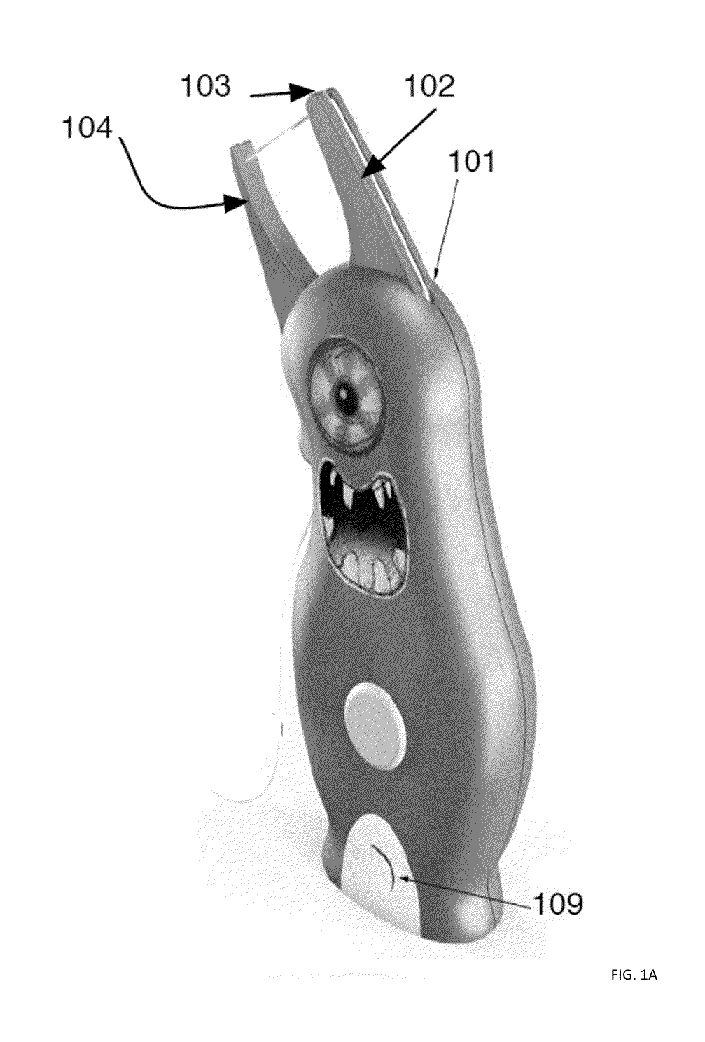

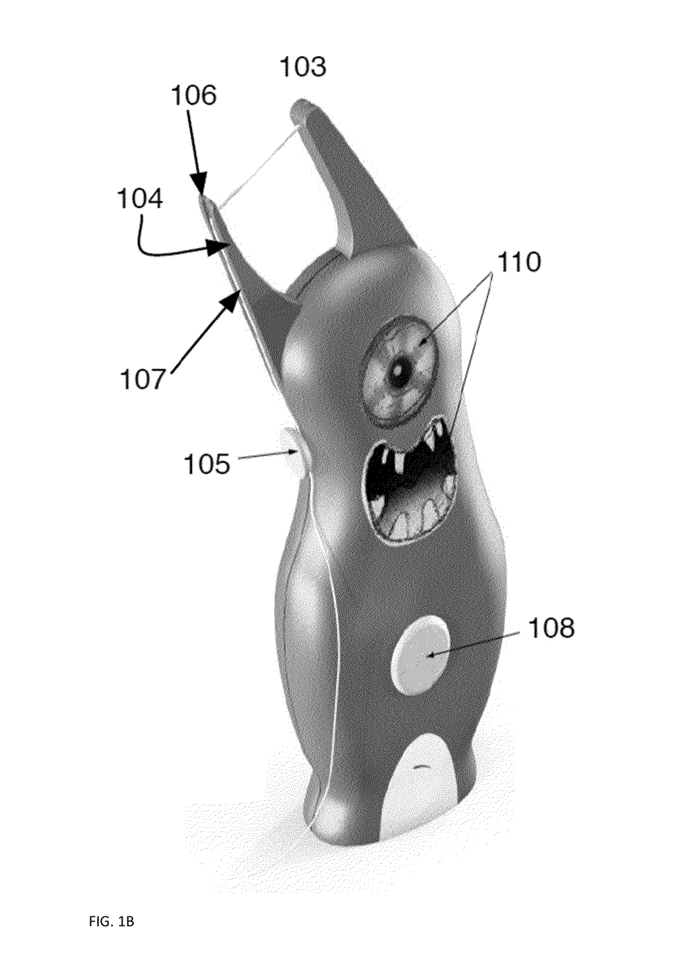

Referring to FIGS. 1A-1B, front perspective views of one exemplary dental device to dispense floss is shown. In one embodiment, a dental flossing device (flosser) includes an elongated clam shell body having top and bottom halves joined by a hinge at a bottom and having a closed position during operation and an open position to access a spool with floss therein. The clam shell halves open to allow replacement of a spool of floss contained therein and are closed during operation.

In the embodiment of FIGS. 1A-1B, the floss is stored in an internal chamber of a case, and the floss is guided through an opening 101 and follows a groove 102 up a prong 103. The floss is threaded between prongs 103, 104. The prong 104 is thinner than prong 103 to allow prong 104 to easily access the tooth portion underneath an arch wire in case the user is undergoing orthodontic treatment. Preferably, a tip 106 of prong 104 is sized such that it can fit underneath the orthodontic wire for brace wearers. The floss then wraps around a cleat 105 to hold floss tension. A tip 106 of prong 104 is positioned relative to the cleat 105 such that the floss is maintained in a groove 107 along the edge of support 104 when stretched from the tip 106 to the cleat 105.

The flosser further includes a user actuated push button 108 that releases the floss spool so a length of floss can be pulled out. The flosser further includes a floss cutter 109 to trim the floss. The floss cutter 109 can be in the front or back of the device. In one embodiment, the cutter is at the base of the flosser. As detailed below, the flosser is a double clam shell casing with a hinge along the bottom. The clam shell can be folded into shape and secured by a latch, as detailed below.

The flosser can include stickers 110 which may be applied to the surface of the flosser to individualize or render the flosser as uniquely identifiable. The personalization of the flosser can also be done with images created by ink pens such as felt pen or by chalk, among others. The uniquely identifiable flosser encourages the user such as a child to enjoy the flossing experience. Further, by uniquely identifying the user of the floss device, the system minimizes potential transfer of bacteria and viruses between users. The flosser further provides a novel decorative design with ease of use. The flosser can advantageously be used by users who wear orthodontic braces, but the flosser can be used to floss teeth with and without braces with equal ease.

The flosser can have different body colors and can be personalized with stickers to create a monster that will motivate kids and teens to floss. The device can be made of flexible, recyclable plastic, or polypropylene, among others, and can be made in a wide range of colors such as green, black, pink, blue, and various glow in the dark colors.

Preferably, the flosser embodiment of FIGS. 1A-1B is shaped like a monster with prongs 103-104 acting as the monster's horns. One of the “horns” or prongs has a predetermined dimension that is thin enough to fit under the wire. The floss then goes between the teeth and under the gum line. The flosser could also be used as a “floss threader” where the floss can be lifted off the prong of the thicker adjacent prong and the thin prong can be placed under the wire and the loose floss held with one hand behind the tooth can also bring the floss in between the teeth. This would allow for the floss to be free moving under the wire.

One embodiment provides an elongated cylindrical pole through which the spool of floss can be inserted or dropped therethrough. The spool can include gears or an encasement to help control the rotation of the spool and the floss release. The button can interact with the spool to control floss advancement without entanglement of the floss.

In one embodiment, the floss is guided inside the interior. In another embodiment, from the inside of the flosser, an opening exists on the upper right side of the circular encasement that the floss will come out of so it can access a hole formed by the top and bottom halves (that can be made of plastic) that comes from the closing of the clam shell body. Upon exiting the hole, the floss is outside of the clam shell body or container.

During use, the floss is threaded up the right side of the inside of the clam shell body or container, slides and fits into a groove or track up along the inside of the flosser or one “horn”. The floss is then threaded through a small hole at the top of the “horn” on one side in this example so that the floss does not come off. The floss crosses over to the left “horn” and threads through a hole and travels down the other side of the “horn” and into a loop on the other side. The free floss then wraps around the button or cleat positioned on the side of the clam shell body. The cleat/button helps to keep the floss across the horns tight while flossing. The user that is flossing unwraps the floss around the button or cleat slightly in order to advance the floss across the horns for a clean piece of floss. The user then re-wraps the floss again to repeat the tightness and the floss advancement is repeated until the user has finished flossing all teeth. A push release button is provided on the front connected to the floss spool that keeps the floss from advancing unless it is pushed and released. If the inside holder for the floss spool has the rotatable gears the floss spool may be replaced by a suitable spool of floss from a floss clam shell body or container that contains a round spool of floss. The cutter near the bottom of the clam shell body can be used to cut and remove the used, soiled floss.

In one embodiment, one horn is slightly thicker than the other horn. This horn embodiment is about % of an inch in height and is slightly angled to the one side in order for the flosser to reach the back (posterior teeth). The horn is approximately 1/8 inch thick. The horn has an indention (track) up one side of the horn so the floss lies inside and does not move around. Alternatively the floss can be inside. The tip of the horn has a small hole similar to an eye of a needle so the floss can thread through it. The floss will then thread across the span to the next “horn” on the other side. This horn will have a hole at the top for the floss to thread through and will be flatter and thinner than the other horn towards the top. The thin horn will fit underneath the arch wire to guide the floss through the teeth and to the gum line. The height will be about % inch long in one implementation. The floss then drops down alongside the other horn and thread through a loop on the “head” of the monster. The floss will then spread across the head to the cleat that the floss can be wrapped around in order to keep the floss taught. The push release button on the front locks the floss spool and keeps the floss from advancing unless the push release button is pushed and released.

When done with one part of flossing, the user unwraps the floss from the button or cleat and pushes the release button in order to advance the floss to a clean piece in order to move on to the next tooth. The soiled floss can then be cut off thereby reducing contamination.

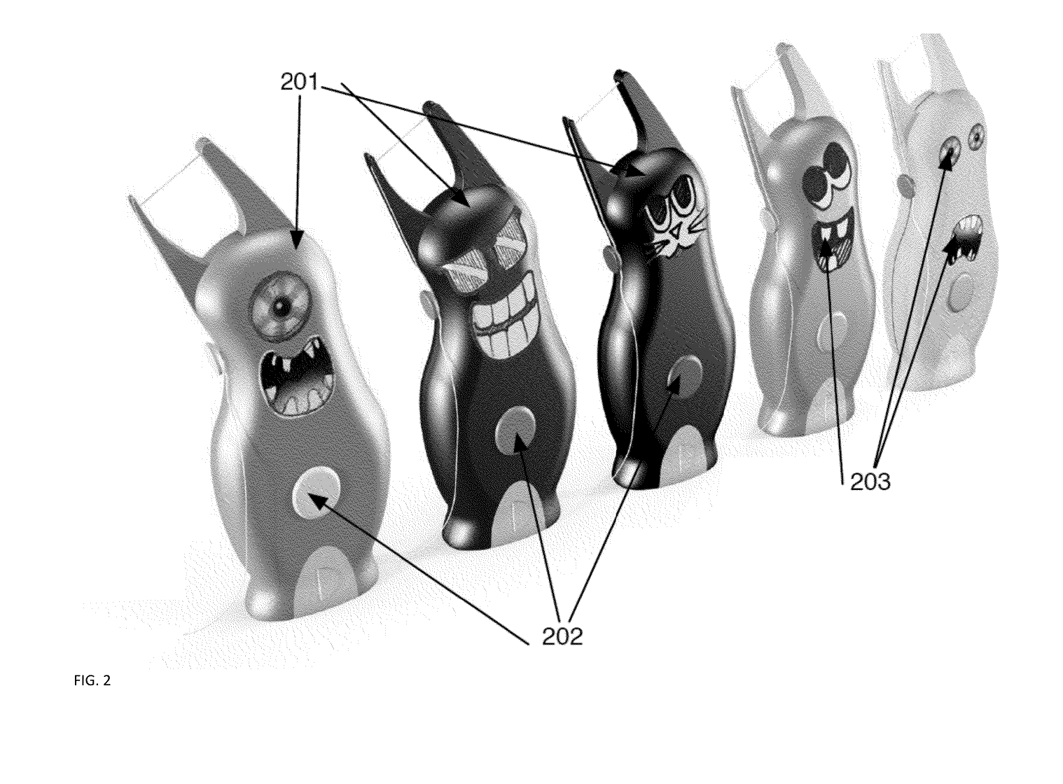

Referring to FIG. 2, non-limiting exemplary “monster” embodiments of personalization of the flossers are shown. A variety of artwork such as stickers with various eyes, mouths, teeth, eyebrows, hair, among others, can decorate the Floss Monster so the owner can personalize and characterize the Floss Monster thereby making it their own tool, creating and motivating the user to floss regularly for healthy gums. Ink pens can also be used to personalize the flosser.

Artwork includes painted images, printed images, and stickers applied to the body of the flossers. The artwork can be positioned on one or more portions of the flosser so as to enhance the cheerfulness and attractiveness of the flosser. The artwork can be secured to the clam shell body through stickers, or can be directly formed during manufacturing, for example by imprinting the artwork before, during or after the manufacture of the flosser. Imprinting can be done via screen-printing, sublimation printing, transfer printing, or using ink pens. Other manufacturing techniques are also conceivable. For example, the artwork can also be generated by coining, punching, gluing or other techniques, which do not only generate a two-dimensional design of the surface but design the corresponding region of the flosser three-dimensionally, similar to a relief. The shaping of the relief can predetermine positions where other artworks are preferably to be arranged. Personalization may also be done through variations in the plastic material used to make the body of the flosser 201, variations in the color, shape and texture of the dispense buttons 202 and variations in artwork 203 applied to the flosser. In this manner, the flosser can be decorated with beautiful designs and patterns suitable for and attractive to kids.

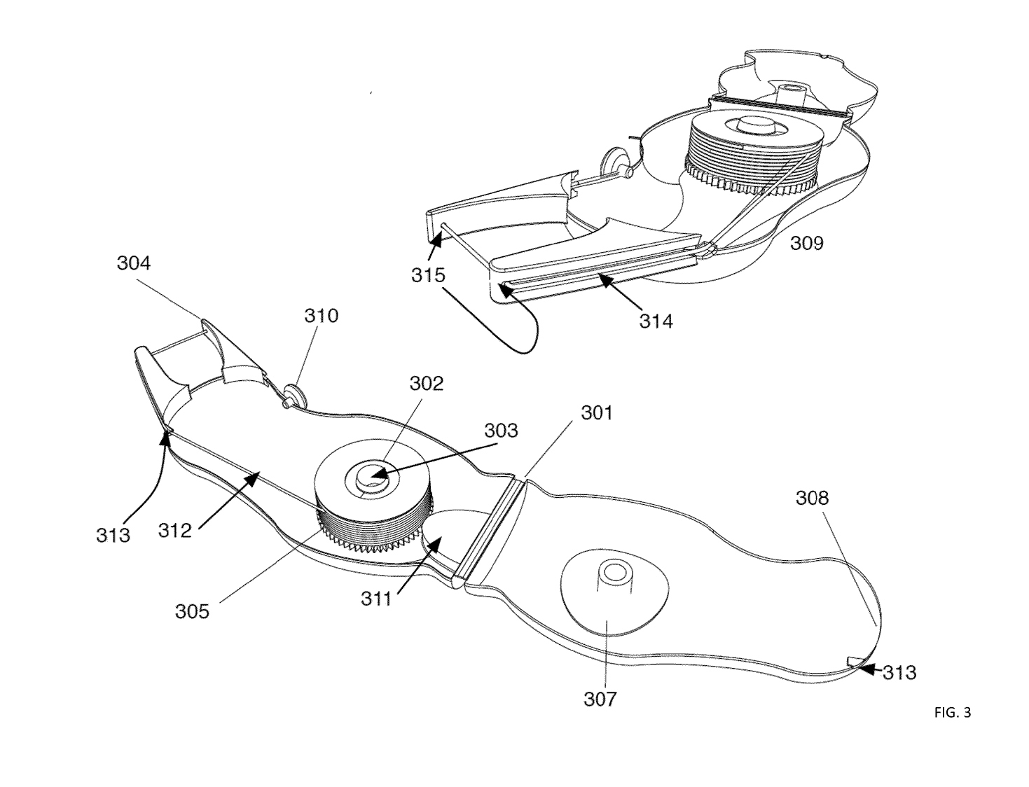

Referring to FIG. 3 embodiments of the flosser with the clam shell case in the open position are shown. The flosser includes a hinge 301 at the bottom of the case (bottom defined when closed). In one embodiment, the hinge is double hinged and when closed, the hinge forms a flat surface so the flosser can stand vertically. The flosser further includes a spool 302 for containing floss material. The spool is mounted on a rotatable shaft 303. The spool is held on the shaft with a spring mechanism 307. In one embodiment the spool includes gear teeth in an edge of the spool that interlocks with a lock mechanism 311 that secures the spool in place. The lock mechanism can be released with the button on the front of the flosser and thereafter the released floss can be dispensed. Non-limiting examples of the spring mechanism include a wave washer as shown and a coil spring, among others.

A strand of floss 312 is dispensed from the spool, is threaded through a guide 313, and is then fit into grooves on the side of the prongs 304. The floss is then stretched across the prongs and finally wrapped on a cleat 310 to be held tightly during use to maintain tension on the floss. For clarity a second view 309 shows the groove 314 on the edge of the prong. At the tip of the prong the floss is fed through an opening or hole 315. The hole 315 may be replaced by latching grooves that allow the floss to be pushed into the groove on threading but hold the floss within the groove when pulled upon during subsequent use. The clam shell body further includes a latch 308 that allows the clam shell to be securely latched during use yet can be opened to replace the floss contained therein.

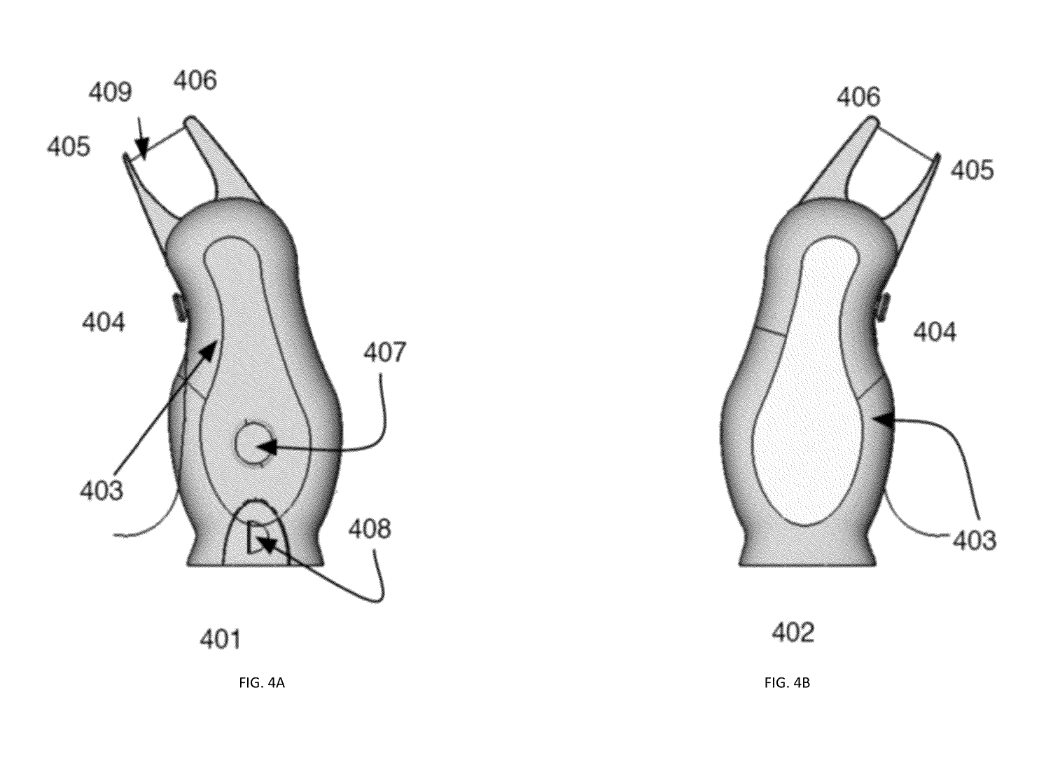

Referring now to FIG. 4, front 401 and back 402 views of one embodiment of the flosser are shown. The embodiment includes a main body 403. The main body includes a cleat 404 on one side of the body to which the floss is attached and held in place with tension during use. Projecting from the top of the body are two prongs 405, 406 through which the floss is threaded. The floss 409 is stretched across the tips of the projections. The stretched portion of floss is used to clean regions between the user's teeth. The prongs 405-406 are seen to be of differing thickness with at least one of the prongs 405 made sufficiently thin that it will fit underneath the wire of braces to allow a user who wears braces to maintain dental hygiene. The flosser further includes button 407 that when pushed releases the locking spool mechanism described earlier to dispense fresh floss.

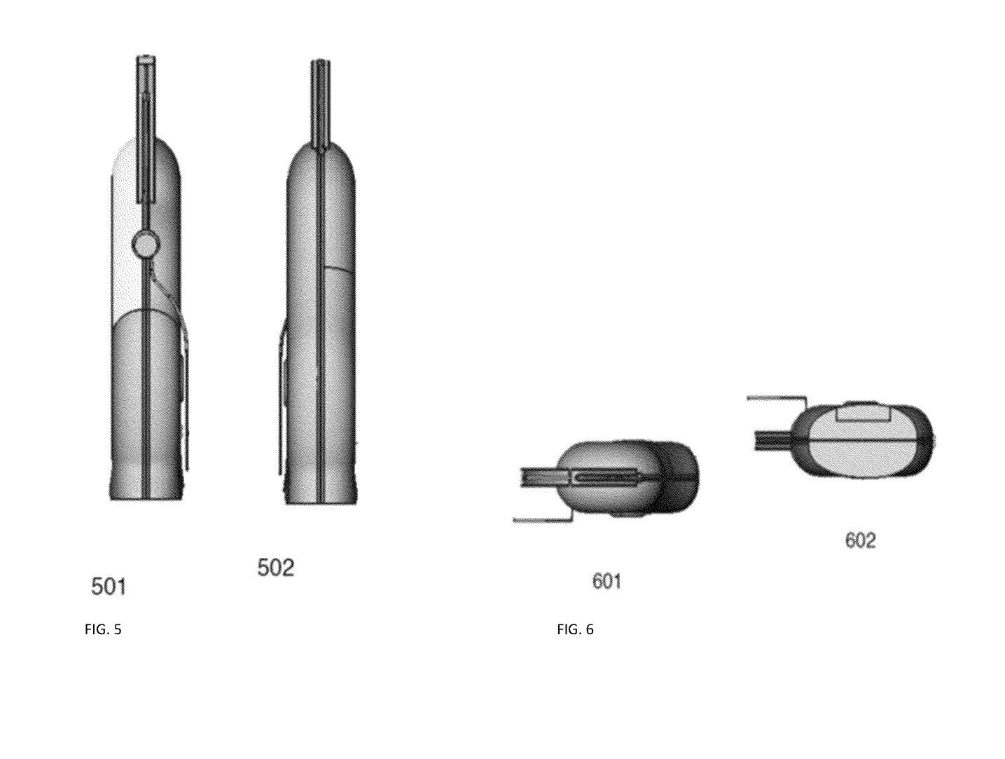

FIG. 5 shows left 501 and right 502 side views of the same flosser, while FIG. 6 shows top 601 and bottom 602 views of the flosser. The bottom view 602 shows that the bottom is sufficiently flat and provides a solid foundation for the flosser to stand vertically for display. Additionally, the ability to stand the flosser reduces contacts by the prongs with potentially soiled surfaces on the washing surfaces and reduces risk of floss contamination.

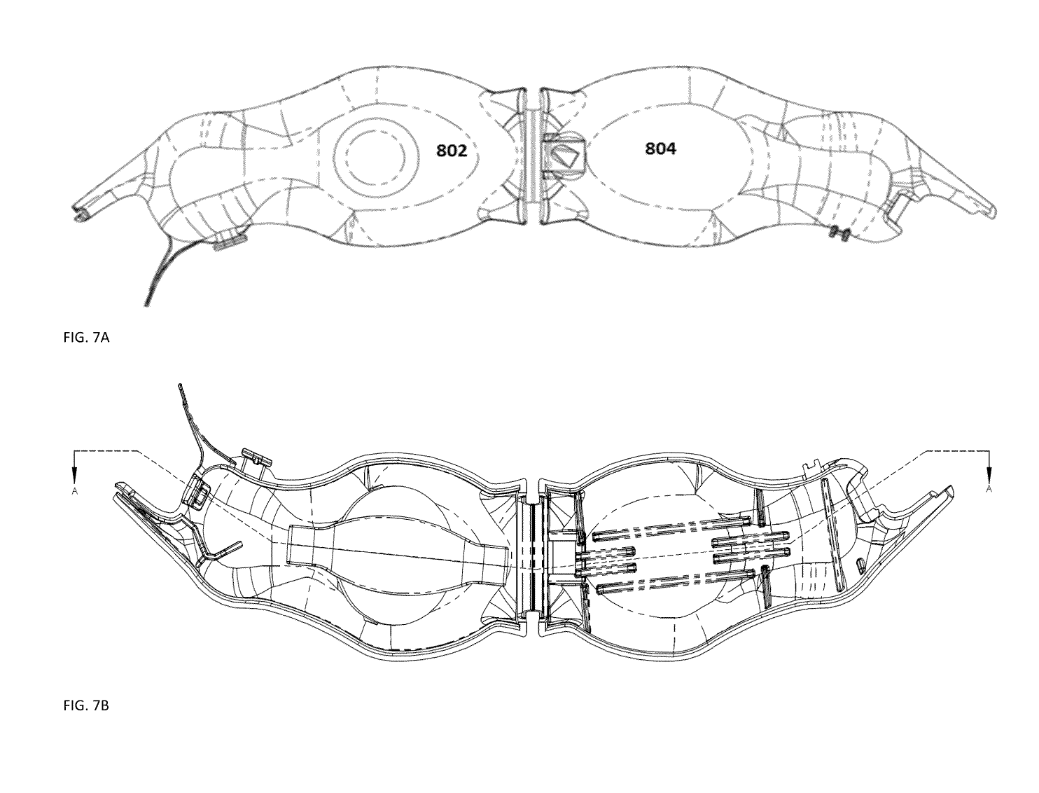

FIG. 7A-7B show another embodiment of a flosser. FIG. 7A shows an exterior view of the flosser, while FIG. 7B shows an interior view of the flosser. As shown in the top view of FIG. 7A, the flosser includes an elongated clam shell body having top and bottom halves 802-804 joined by a hinge at a bottom and having a closed position during operation and an open position to access a spool with floss therein. The clam shell halves 802-804 open to allow replacement of a spool of floss contained therein and are closed during operation.

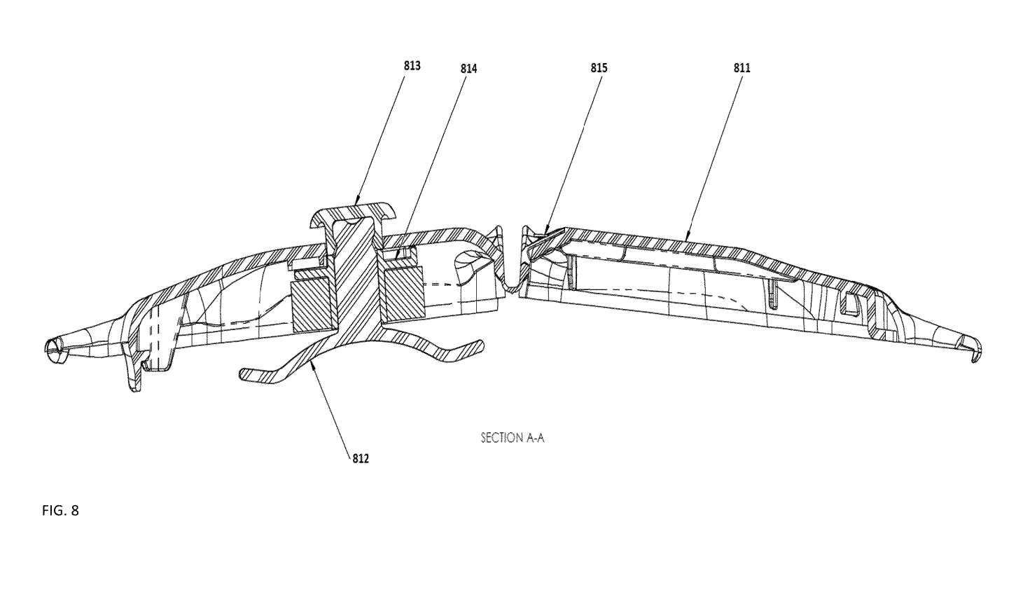

FIG. 8 shows a cross-sectional side view of the flosser of FIG. 7. The body 811 is a continuously formed clam shell body. A button 813 is provided to allow the user to release the floss from the spool. The button 813 is urged upwardly through a spring axle 812 which is formed of a curved dome that eventually flattens into a flexible circular rim. A spool, bobbin or reel 814 holds the floss thread therein. During actuation of the button 813, then entire assembly including the spring axle 812 is pushed down to allow the bobbin 814 to rotate and thread to be pulled out of the interior. The spring axle 812 is initially curved until the depression. As the button 813 is depressed, the spring axle 812 flexes and gradually becomes flattened. When the button 813 is released, the spring axle 812 returns to its curved state.

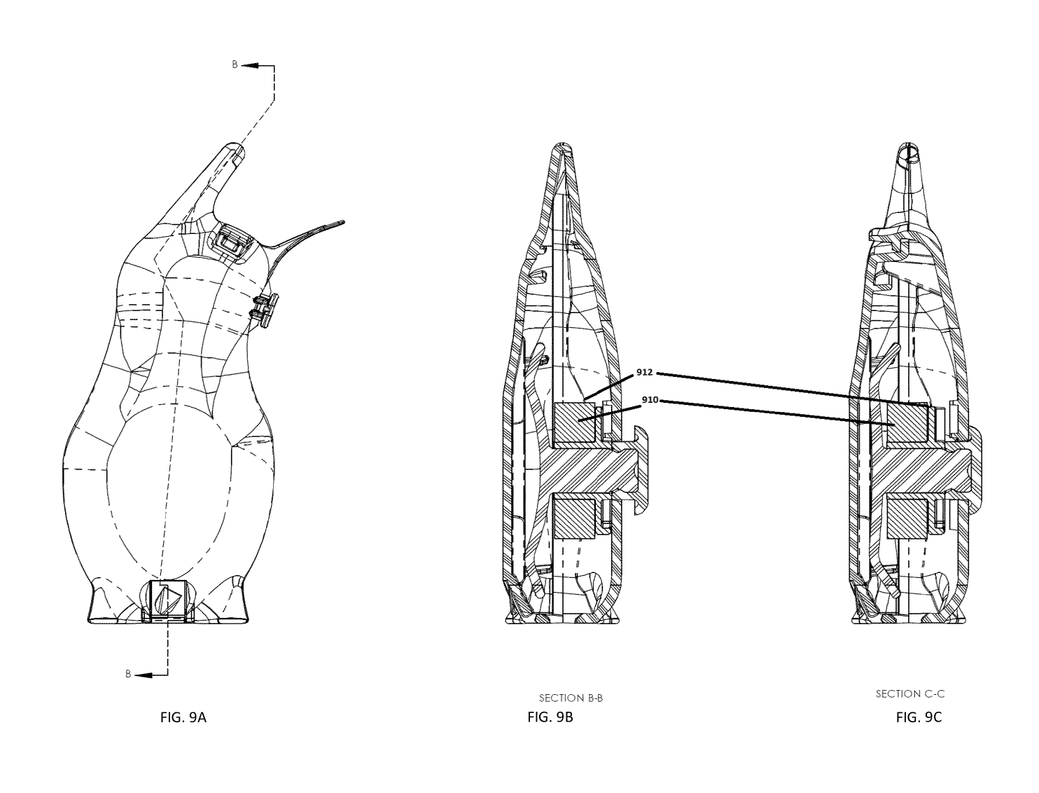

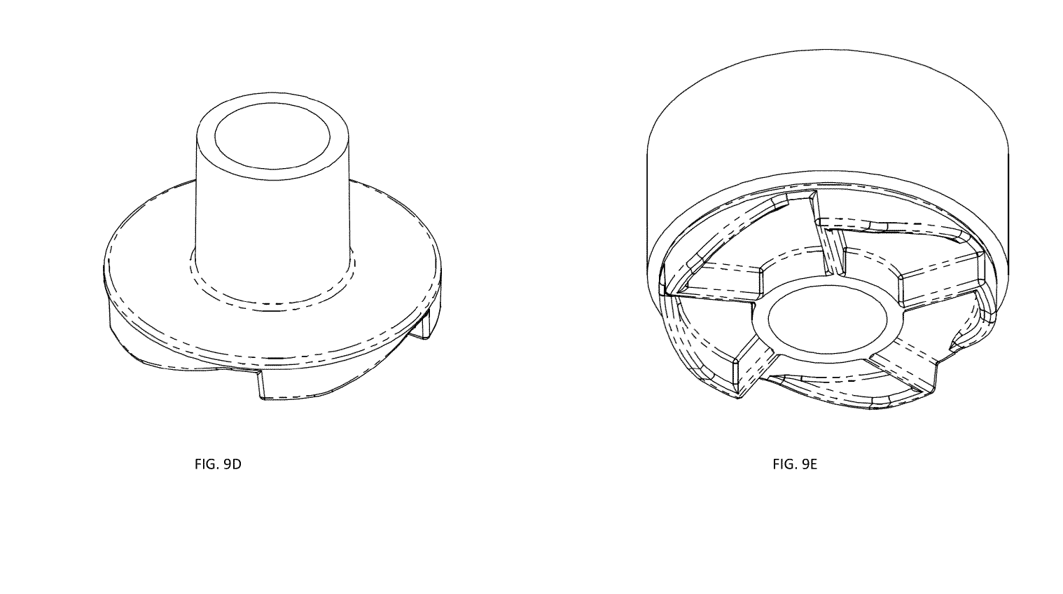

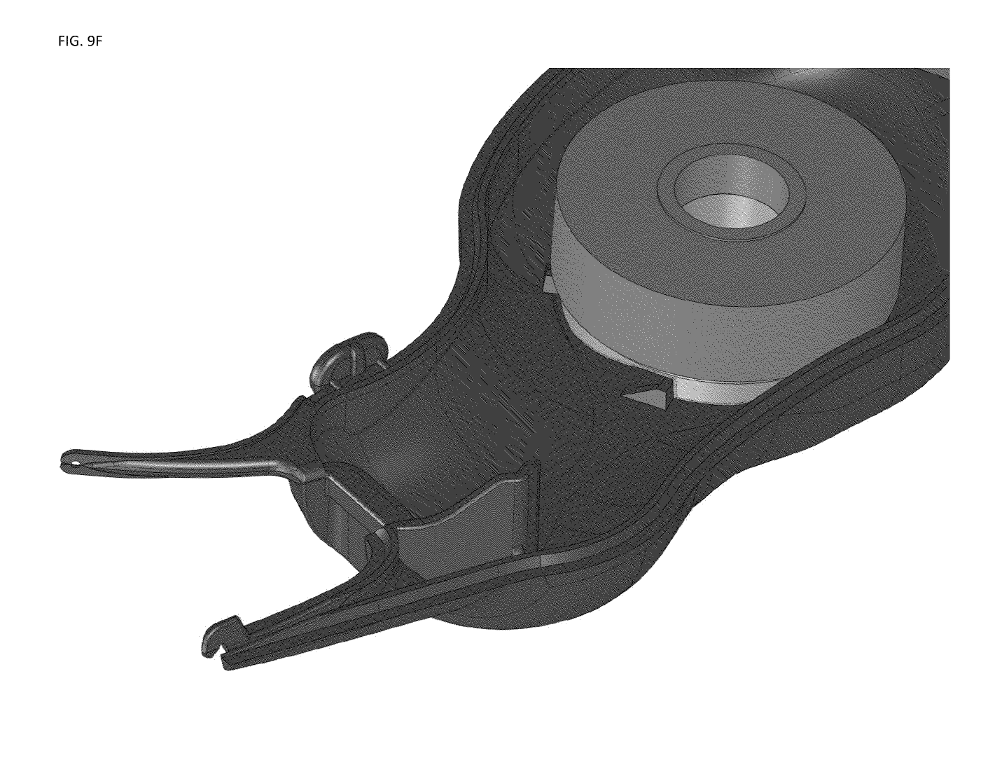

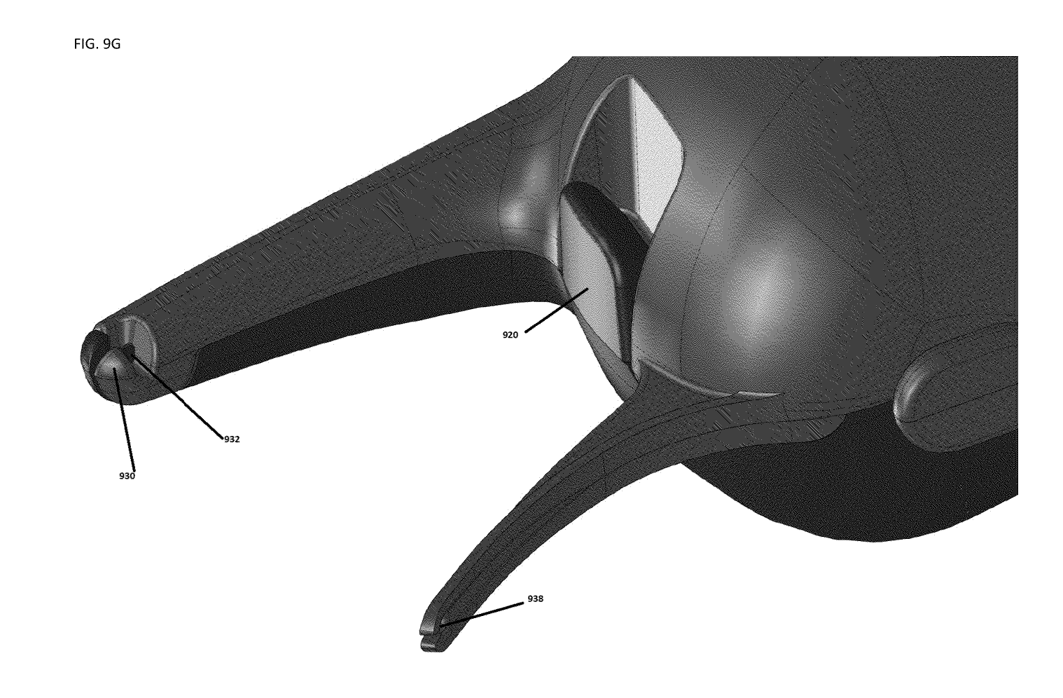

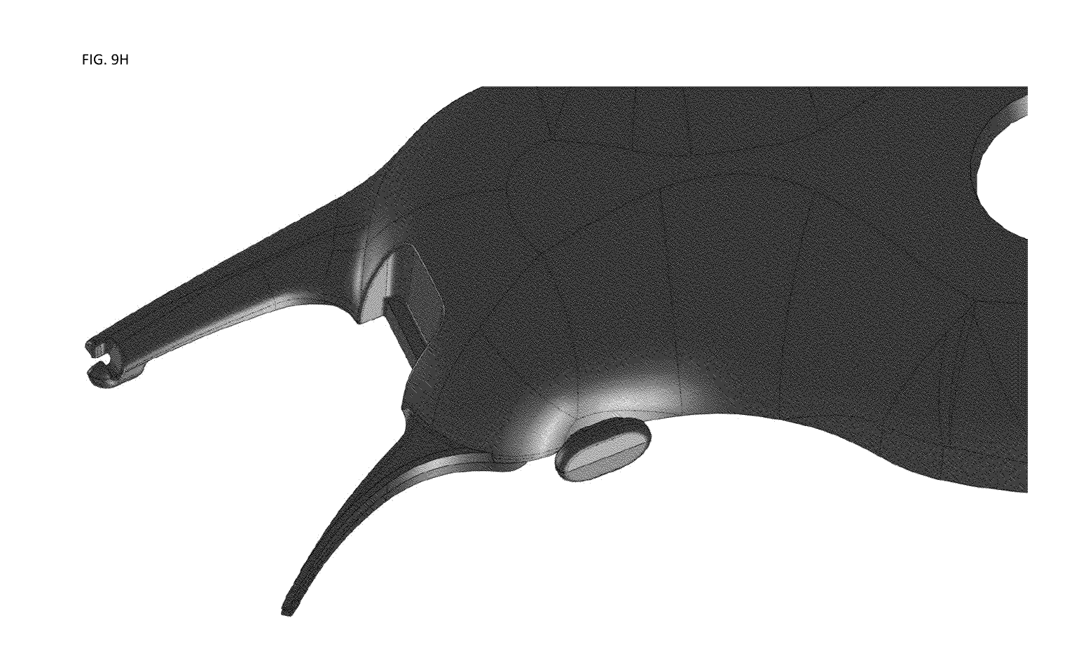

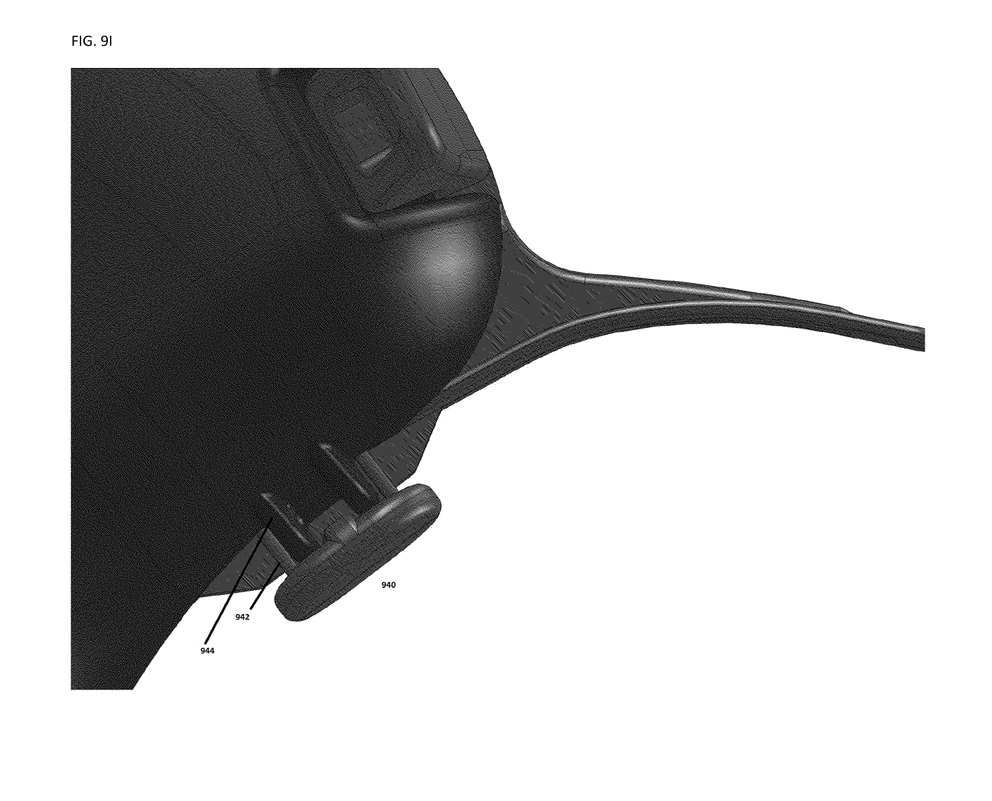

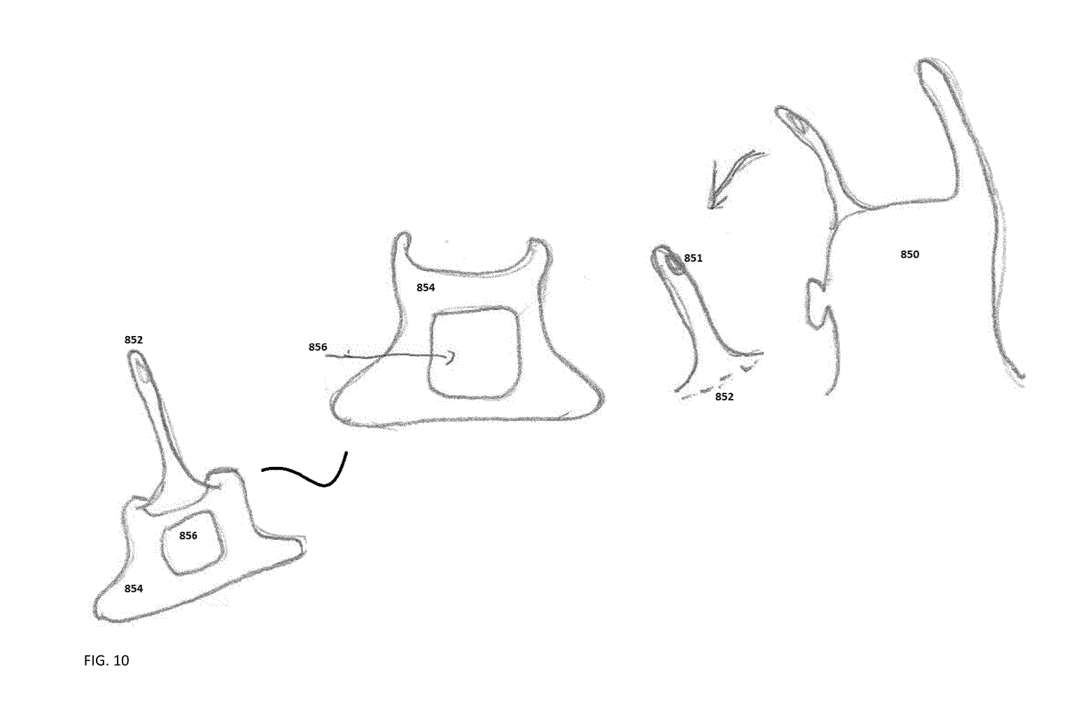

FIG. 9A shows a cross-sectional view of the flosser, while FIGS. 9B-9C illustrate the operation of the button/spring axle. In FIGS. 9B-9C, when the button 813 is pushed, the spring axle is flexed, disengaging the ratchet containing floss 910 on the body from the ratchet features on the bobbin. This allows the bobbin to spin freely on the axle as the user pulls floss 910 off the bobbin. The user releases the button 813, allowing the ratchet containing floss 910 to engage, which stops the spin and anchors the bobbin end of the floss. The user can pull the floss tight, winding it around the cleat (not shown in this view) to anchor the other end of the floss. The excess floss can be cut off by the cutter.

FIGS. 9D-9E show exemplary views of a bobbin and a bobbin with a spool of floss, respectively. In this embodiment, the bobbin has a cylindrical extension on the top of the bobbin and adapted to receive a spool of thread. The bobbin also has a plurality of curved protrusions on the bottom of the bobbin to limit the rotation of the bobbin to a predetermined number of degrees so that only a certain amount of floss can be dispensed at a time.

FIG. 9F-9H show exemplary views of the top portion of the flosser of FIGS. 7A-7B with two prongs and a latch thereon. This embodiment allows the floss to be pushed into a groove on threading but holds the floss within the groove when pulled upon during subsequent use. The clam shell body further includes a latch that allows the clam shell to be securely latched during use yet can be opened to replace the floss contained therein.

Viewing FIGS. 9F-9H together, a latch 920 locks the two halves of the elongated clam shell body at the top of the shell body. The bottom of the shell body halves are joined by a hinge. When the latch 920 is engaged, the shell body is in a closed position for operation. When the latch 920 is disengaged, the shell body is in an open position to allow access a spool of floss in the shell body. The floss eventually is threaded through tip 930 with an arm 932 in the thick prong projecting in the direction of the latch 920 to engage the floss. The floss is also threaded through an eyelet 938 on the thin prong.

FIG. 9I shows an exemplary cleat. This embodiment is a plate 940 or button type cleat with four pinch buttresses: two buttresses 942 extend along the part line to the top and bottom and two buttresses 942 stand towards the prong. The floss is wound around the body of the cleat and is pinched between the button or plate and the pinch buttresses. A rib 944 is placed in the back of the plate 940 between the two standing pinch buttresses. This rib serves to exaggerate the pinch by forcing the floss to zig-zag past the pinch buttresses and that center rib.

In one embodiment, the flosser can be used as a floss threader for hard to reach and tight contacts where the device will not fit as a whole. In one embodiment, the skinny prong 852 can be used with the flosser 850. In another version, a skinny prong 852 with an eyelet hole 851 is removable from the flosser 850 and used independently and subsequently be snappably inserted into a holder 854. The holder 854 contains two depression regions 856 on either side of the holder and adapted to be held by a thumb and a forefinger. The skinny spike 852 will snap out of its place on the original body and snap onto a thumb and forefinger holder 854, turning it into a floss threader.

In one embodiment, the base or holder of the floss threader spike has a triangular shape with a depression on the top of the triangle shape where the point of a triangle would be. This will have a snap feature that will accept the spike end and become a device that will have a depression on either side of the triangle base for the thumb and forefinger to hold while guiding the spike under the braces wire. The spike can be removed from the triangular base and snapped back on to the flosser device body for regular flossing action as a floss holder. The holder can be used as a floss threader without detaching it from the flosser.

In one exemplary use of the floss holder with braces, the user should:

1. Release 8″ of floss and pull by pushing front button

2. Insert end of floss through the hole in the skinny prong, pull through and wrap around the side cleat a number of times to create tension

3. Insert the skinny prong under the braces wire in between each brace and slide Floss Monster up and down each side of the tooth gently to remove plaque between your teeth

4. Advance the floss to a clean segment by pushing front button to release floss to pull.

a. Unwrap from the side cleat, push the front button, pull floss to clean segment, wrap around cleat, and cut off the soiled floss with cutter on the back

5. Repeat for each tooth

In one exemplary use as a floss threader or aid for crowded teeth, the user should:

1. Lift floss out of both prongs

2. Push button to release 8″ of floss pulling out from the top of the thick back prong, leaving a long loose length of floss

3. Thread the loose floss through hole in the skinny prong leaving ¼″ out of skinny prong

4. Insert skinny prong under brace wire and grab the loose floss piece that is now under the wire. Pull through wire and grab floss, wrap around your finger to floss the traditional way

The user can change the floss bobbin as follows:

1. Lift latch on Floss Monster head to open body

2. Remove button from front and disassemble the flat spring from the button

3. Remove empty bobbin

4. Replace with new bobbin with the gear facing up toward the button hole on the shaft of the flat spring

5. Guide floss up through the channel on the thick prong and close

6. Maneuver floss through the over hangs of the thick prong

7. Re-insert floss through the skinny prong hole, wrap around cleat and you are ready to use again as a floss holder.

The flosser can also be used as a “floss threader”. The floss can be lifted off the prong of the thicker adjacent prong and the thin prong can be placed under the wire and the loose floss held with one hand behind the tooth can also bring the floss in between the teeth. This would allow for the floss to be free moving under the wire.

The dental floss device apparatus and method has many of the advantages of the hand-held dental floss devices and many novel features that result in a new dental floss device which is not anticipated, rendered obvious, suggested, or even implied by any of the prior art hand-held dental floss devices, either alone or in any combination thereof. The dental floss device may be easily and efficiently manufactured and marketed. The dental floss device is of a durable and reliable construction. The dental floss device offers a low cost of manufacture with regard to both materials and labor, and which accordingly is then susceptible of low prices of sale to the consuming public, thereby making such dental floss device economically available to the buying public. The dental floss device can conveniently dispense a predetermined amount of dental floss. The dental floss device provides a housing with dental floss stored therein. Also included is at least one dental floss dispensing assembly for dispensing a predetermined length of the dental floss from the housing.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The advantages, along with the various features of novelty of the preferred embodiments, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Those skilled in the art will appreciate that various adaptations and modifications of the preferred embodiments can be configured without departing from the scope and spirit of the invention.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A dental floss device (flosser), comprising:
an elongated clam shell body having top and bottom halves joined by a hinge at a first end and having a closed position during operation and an open position to access a spool of floss therein, wherein the hinge in the closed position forms a base to allow the clam shell body to stand on a surface;
a pair of spaced apart prongs extending from a second end of said elongated clam shell body to receive floss therethrough, each prong having a different thickness;
a ratchet coupled to the spool to prevent turning of the spool when engaged; and
a button on one surface of the clam shell body that releases the ratchet and allows floss to be dispensed and engages the ratchet when the button is released to hold the floss.

2. The flosser of claim 1, wherein the top and bottom halves are secured by a latch, said latch allowing the clam shell body to be opened for replacement of the floss supply wrapped around the spool within the clam shell.

3. The flosser of claim 1, comprising a guide on the top of the clam shell to guide the floss from the spool.

4. The flosser of claim 1, wherein each prong including a groove along an edge to guide the floss along the prongs.

5. The flosser of claim 1, comprising a cleat on a side of the clam shell body where the floss is wound and held in place to maintain floss tension.

6. The flosser of claim 1, comprising a spring mechanism to hold the spool in place and engage the ratchet.

7. The flosser of claim 1, comprising a floss cutter to cut the floss.

8. The flosser of claim 1, comprising one or more artwork, stickers, or decorations secured to the clam shell body.

9. The flosser of claim 1, wherein the hinge is a double hinge and when closed the hinge forms a flat surface so the flosser can stand vertically.

10. The flosser of claim 1, wherein one prong is thinner than the other prong and adapted to fit under an arch wire.

11. The flosser of claim 10, wherein the thin prong is removable.

12. The flosser of claim 11, comprising a holder including regions to receive a grip from a thumb and a fore finger.

13. The flosser of claim 12, wherein the thin prong is received by the holder.

14. The flosser of claim 12, wherein the holder comprises a triangular shaped base with a depression on top of the triangular, comprising a depression on both sides of the triangle base for the thumb and forefinger to hold while guiding the thin prong under a brace wire.

15. A dental floss device (flosser), comprising:
an elongated clam shell body having top and bottom halves joined by a hinge at a first end and having a closed position during operation and an open position to receive a spool with floss therein;
a pair of prongs extending from a second end of said elongated clam shell body, each prong receiving floss threaded therethrough;
a cleat on a side of the clam shell body where the floss is wound and held in place to maintain floss tension;
a ratchet on the spool to prevent turning of the spool when engaged; and
a button on one surface of the clam shell body that releases the ratchet and allows floss to be dispensed and engages the ratchet when the button is released to hold the floss.

16. The flosser of claim 15, wherein the top and bottom halves are secured by a latch, said latch allowing the clam shell body to be opened for replacement of the floss supply wrapped around the spool within the clam shell.

17. The flosser of claim 15, comprising a guide on the top of the clam shell to guide the floss from the spool.

18. The flosser of claim 15, wherein each prong including a groove along an edge to guide the floss along the prongs.

19. The flosser of claim 1, wherein the button is coupled to a spring axle.

20. The flosser of claim 1, comprising one or more artwork, stickers, or decorations secured to the clam shell body.
